(19) United States
(12) Patent Application Publication
(10) Pub. No.: US 2013/0063481 A1
(43) Pub. Date: Mar. 14, 2013

(54) Optical System with Dynamic Correction of the Image

(71) Applicants: Bruno Coumert, Saint Heand (FR); Xavier Rejeaunier, Saint Heand (FR)

(72) Inventors: Bruno Coumert, Saint Heand (FR); Xavier Rejeaunier, Saint Heand (FR)

(73) Assignee: THALES, Neuilly-sur-Seine (FR)

(21) Appl. No.: 13/698,628

(22) PCT Filed: May 12, 2011
(86) PCT No.: PCT/EP11/57727

§ 371 Date: Nov. 16, 2012

(30) Foreign Application Priority Data
May 18, 2010 (FR) 10 02081

(51) Int. Cl. G09G 5/00

(52) U.S. Cl. 345/619

(57) ABSTRACT

In the field of wide field or wide angle optical systems, an optical system comprises at least a first optical element and a second adaptive optical element comprising at least one active component, capable of modifying an optical wavefront virtually instantaneously according to a predetermined law, said optical device being designed to produce an image of an illuminated object whose geometric and photometric characteristics are known, the object and the image being at a finite distance or at infinity. The object is decomposed into a plurality of adjacent regions and the active component is arranged in such a manner that, to each region of the object there corresponds at least one predetermined law for modification of the wavefront received by the active component in such a manner that the geometric aberrations of the optical system for said region of the object are minimized.

The field of the invention is that of wide-field or wide-angle optical systems designed for video imaging applications. The invention is just as applicable both to the reproduction of images or to the recording of images. In the first case, the optical system according to the invention is disposed in front of a display; in the second case, the optical system is disposed in front of a photosensitive matrix sensor.

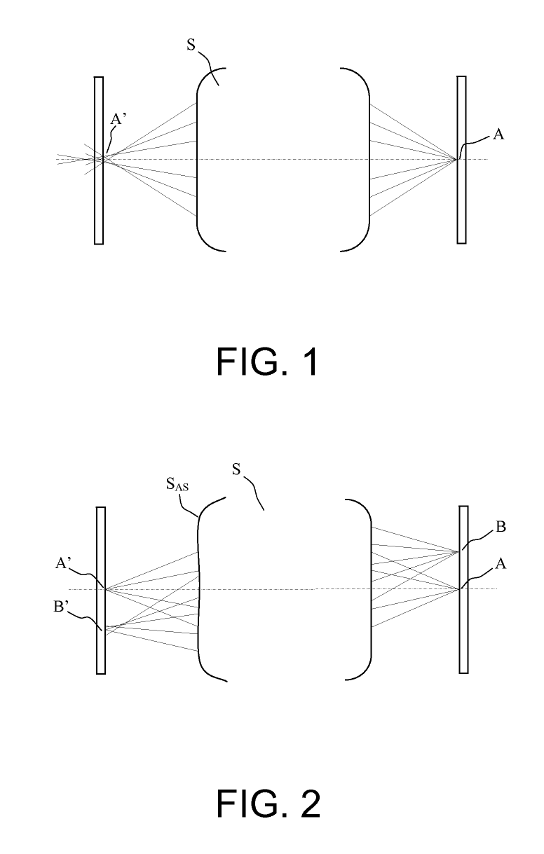

All simple optical systems, irrespective of their functions, are composed of primary optical elements such lenses, mirrors or prisms. It is shown that, except for some very specific applications, the image of an illuminated object through a simple optical system is not perfect; it is said to be non-stigmatic. FIG. 1 illustrates this problem. The image of the dot A through the optical system S does not, at any location, give a point-like image A′. The deformations of the image are called aberrations and these are conventionally categorized into geometric aberrations and chromatic aberrations. In the case of FIG. 1, the aberrations are referred to as spherical aberrations. It is also possible to express the aberrations as wavefront deformations. It is shown that these aberrations increase greatly when the aperture of the optical system or the dimensions of the object or the optical field increase.

In order to best compensate for these aberrations, complex optical systems generally comprise several optical elements or several groups of optical elements arranged to be optimized in such a manner that the resulting aberrations are as insignificant as possible. Generally speaking, it is deemed that the optical aberrations are perfectly corrected when the image “spot” produced by the corrected system is of the order of magnitude or smaller than that given by optical diffraction which is the ultimate limit of quality for optical systems.

Of course, the higher the number of optical elements, the greater the number of parameters that may be optimized and the more the optimization allows the optical aberrations to be reduced. On the other hand, the cost, the mass, the size and the complexity of the system increase proportionately. Any optical system is therefore a compromise between the image quality and the complexity of the optical architecture. These difficulties are further multiplied when the optical system is not a centered system, in other words comprising an axis of symmetry of rotation but an off-axis system.

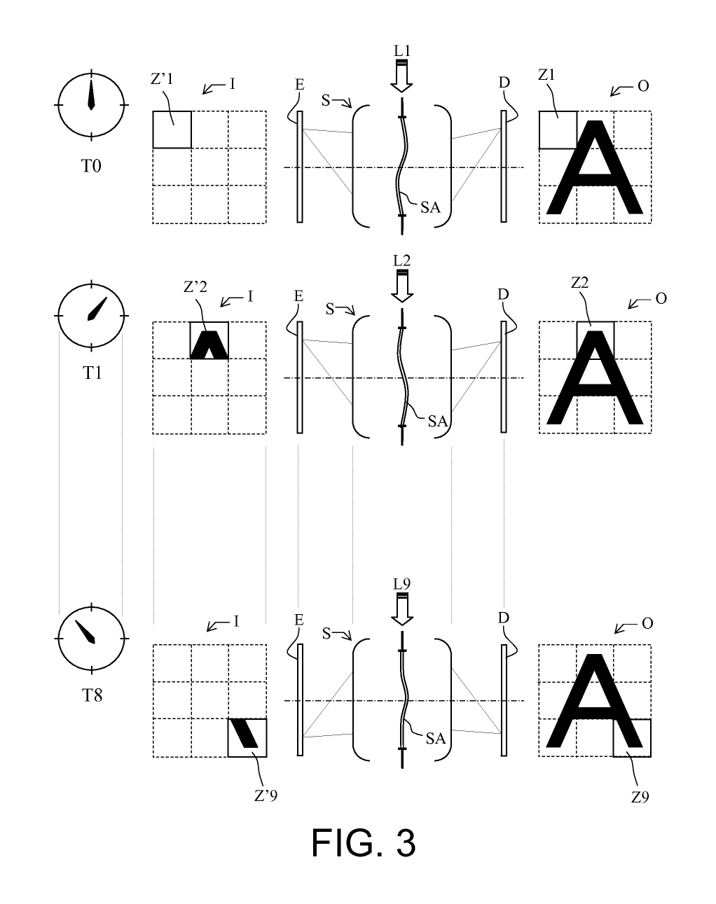

Generally speaking, optical elements are composed of spherical optical surfaces which are simpler to produce but which lead to significant geometric aberrations. In order to reduce the number of optical elements, it is possible to use aspherical optical surfaces or surfaces referred to as “free-form”. However, the use of aspherically formed surfaces is still not the panacea. Indeed, the optimization phase is carried out for the entire object “field” using a grid of object points covering the entirety of the field. However, the optical aberrations depend on the position of said points in the object field. The aberrations to be reduced in the center of the field are different from those at the edge of the field. By using an optical element comprising an aspherical surface, it is possible to eliminate almost completely the aberrations for a portion of a given field, for example for the object points situated on the optical axis of the system or close to the axis. In contrast, this aspherical surface does not allow the aberrations to be perfectly corrected for another portion of the object field. Consequently, the use of an aspherical surface allows an “averaged” reduction of the aberrations over the whole of the field but does not allow them to be completely eliminated. FIG. 2 illustrates this principle. The system S comprises an aspherical surface S_{AS}. The latter allows the aberrations to be perfectly corrected in the center of the field. Thus, the image A′ of the object dot A situated on the axis is point-like. In contrast, it does not allow the aberrations of the object dot B situated in the field to be corrected. The image B′ of the point B is no longer point-like.

A large number of optical systems are designed for video applications, either for recording or for reproduction, in other words the images are recorded or reproduced dynamically at a certain frequency, typically of several tens of hertz.

Optical devices using optical systems referred to as active optics also exist which allow an optical surface or an optical thickness to be deformed dynamically in real time either to correct a shape defect of the original surface, or to correct an object deformed by the passage through the Earth's atmosphere, for example.

The optical system according to the invention is based on the three principles described hereinabove which are:
The correction of the geometrical aberrations of a defined part of an object field by an optical system is possible in an almost perfect manner by means of an optical element with an appropriate shape;
A video image, time-like by nature, may be divided up into a plurality of separate regions;
Optical components with active optics exist that are capable of making instantaneous geometrical corrections.

More precisely, a first subject of the invention is an optical system comprising at least a first optical element and a second adaptive optical element comprising at least one active component, in other words a component capable of modifying an optical wavefront virtually-instantaneously according to a predetermined law, said optical device being designed to produce an image of an illuminated object whose geometric and photometric characteristics are known, the object and the image being at a finite distance or at infinity, characterized in that, the object being composed of a plurality of adjacent regions, to each region of the object there corresponds at least one predetermined law for modification of the active component in such a manner that the geometric aberrations of the region of the image given by the system and corresponding to said region of the object are minimized.

Advantageously, the active component is of the dioptric or catoptric type.

Advantageously, if the illuminated object emits over a polychromatic spectrum, for a given region, there exist several predetermined laws for modification of said active component, each law corresponding to a predetermined field of wavelengths of the polychromatic spectrum of the illuminated object.

Advantageously, the adjacent regions composing the object are of different size, the size of each region being adapted to the amplitude and to the shape of the geometric aberrations to be corrected.

Advantageously, the adaptive optical element is disposed in the neighborhood of the pupil of the optical system.

The invention also relates to a display system comprising at least one display device and an optical system such as defined hereinabove, said system being arranged so as to produce an image at infinity of the illuminated object emitted by the display, characterized in that the display device emits each illuminated object in a sequential manner, each region being emitted for a predetermined period of time, the predetermined law for modification of the active component corresponding to said region being applied to the active component for said predetermined period of time.

Advantageously, at least two regions emitted successively are adjacent.

Advantageously, the system is arranged in such a manner as to be carried by the head of a user.

Lastly, the invention relates to a system for acquisition of images comprising at least one photoreceptor surface and an optical system such as defined hereinabove, said system being arranged in such a manner that the image of the illuminated object is focused on the photoreceptor surface, characterized in that the photoreceptor surface acquires the image of the object in a sequential manner, each region being acquired for a predetermined period of time, the predetermined law for modification of the active component corresponding to said region being applied to the active component for said predetermined period of time.

Advantageously, at least two regions acquired successively are adjacent.

The invention will be better understood and other advantages will become apparent upon reading the description that follows presented by way of non-limiting example and thanks to the appended figures amongst which:

FIG. 1, already discussed, shows a simple optical system not corrected for the optical aberrations;

FIG. 2, already discussed, shows an optical system corrected for the optical aberrations on the optical axis;

FIG. 3 shows the principle of operation of an optical system according to the invention at three different acquisition times;

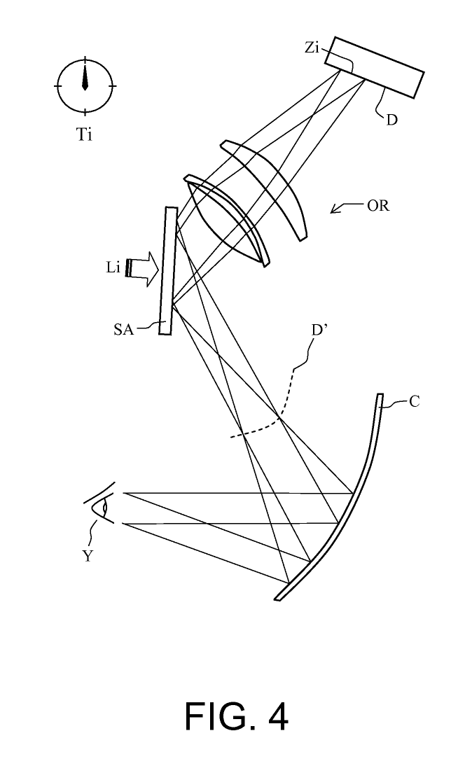

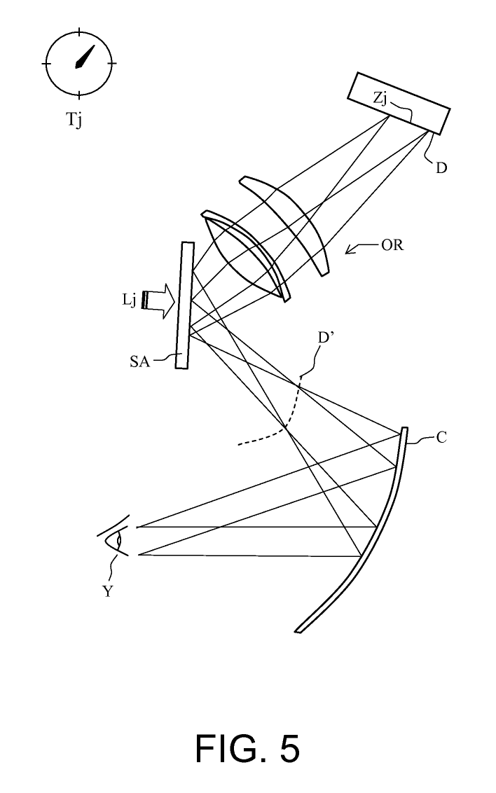

FIGS. 4 and 5 show two cross-sectional views of a display system according to the invention at two different acquisition times.

FIG. 3 shows the general principle of operation of an optical system according to the invention. Since the operation of the device is sequential, FIG. 3 comprises three diagrams showing the system according to the invention at three different times T0, T1 and T8 represented by a timing diagram.

The optical system S forms an image I of an object O. In the case in FIG. 3, for simplicity, the object O and the image I are at a finite distance. However, the invention is just as applicable to an object situated at infinity or to an image situated at infinity. When the object is at infinity and the image at a finite distance, the optical system is designed to be integrated into a photoreceptor device of the camera type. When, on the other hand, the object is at a finite distance and the image at infinity, the optical system forms a part of a display device which may be a helmet viewer. By way of example, the object in FIG. 3 is a square comprising a capital A shown in black on a white background.

The optical system S in FIG. 3 comprises a certain number of optical elements which are not detailed in this figure and whose optical function is to form an image of the object that is roughly corrected for the geometric aberrations. This system also comprises an adaptive optical element capable of modifying an optical wavefront in a virtually instantaneous manner according to a predetermined law. This adaptive element can be disposed in the pupil of the optical system for example. This adaptive element comprises an active component which may be used in transmission or in reflection. In the case in FIG. 3, the active component is a deformable active surface. The technologies employed in the fabrication of this active component can be based on liquid crystal matrices, on micro-mirrors, devices known under the name of “MEMS”, or on deformable mirrors with continuous membranes.

In FIG. 3, the object square is divided up into 9 adjacent square regions Z of identical size and numbered from Z1 to Z9. It goes without saying that the regions can be of different size or shape depending on the requirements of the application envisioned, the geometrical and optical characteristics of the optical system, etc. The division into 9 regions is given only by way of example. 9 image regions numbered from Z1′ to Z9′ correspond to these 9 object regions. For each region of the image square, the law of deformation L of the active surface is optimized in such a manner that the geometric aberrations of the image of said region through the optical system are as insignificant as possible. Thus, in the case in FIG. 3, 9 laws of deformation of the active surface denoted L1 to L9 correspond to the 9 regions of the object.

By way of example, if the optical system forms a part of a display device, the object is formed on the surface of an imaging device D at a certain frequency F, in other words the total time T for displaying the object is equal to 1/F. The image is formed on a screen E. The operation of the device is as follows.

During a first period of time TZ1, starting at time TO, ending at time T1 and equal to T/9, the display device only displays the region Z1 and the law applied to the active surface is L1 as shown by the first diagram in FIG. 3. Consequently, since the law applied allows the aberrations of the system to be perfectly corrected, the region Z1′ observed by the user is perfect.

Subsequently, during a second period of time TZ2, starting at time T1, ending at time T2 and equal to T/9, the display only displays the region Z2 and the law applied to the active surface is L2 as shown by the second diagram in FIG. 3. Once again, the law applied allows the aberrations of the system to be perfectly corrected, the region Z2′ observed by the user is perfect.

The process continues up to the ninth period TZ9, starting at time T8, ending at time T9 and equal to T/9 where the law applied is L9. Thus, region by region, the optical system allows a perfect image to be reconstructed. Of course, the display frequency must be high enough for the user not to notice the changes of region.

In the above discussion, for reasons of clarity, the optical system described forms a part of a display system. In the same fashion, a recording system may be implemented using the same principle. In this case, the system is arranged in such a manner that the image of the illuminated object is focused on the photoreceptor surface and the photoreceptor surface acquires the image of the object in a sequential manner, each region being acquired for a predetermined period of time, the predetermined law of deformation of the active surface, when the active component is an active surface, corresponding to said region being applied to the active surface for said predetermined period of time. This acquisition may proceed adjacent region after adjacent region or in a predetermined order.

In the above discussion, the optical systems according to the invention are dedicated to the correction of geometric aberrations. Chromatic aberrations may also be corrected. In this case, if the illuminated object emits over a polychromatic spectrum, for each given region, several laws of deformation of the active surface are determined, each law corresponding to a predetermined wavelength of the polychromatic spectrum of the illuminated object. Upon recording or upon reproduction, recording or emission takes place successively for each region of the object within a predetermined spectral range situated around one of the wavelengths and the law of deformation of the active surface corresponding to said region and to said wavelength is simultaneously applied. For example, for a given region, if the optical system is a display system comprising a display device, the illuminated object displayed may be decomposed into three primary components red, green and blue. In this case, for each given region of the object, firstly the red component is displayed and the law of deformation corresponding to red is applied, then the green component with the “green” law of deformation, then the blue component with the “blue” law of deformation.

By way of exemplary embodiment, FIGS. 4 and 5 show two cross-sectional views of a helmet display system according to the invention at two different reproduction times Ti and Tj. The display system in FIGS. 4 and 5 conventionally comprises a display device D, an optical system composed of an optics-relay OR, a reflecting mirror SA, a combiner C. In the present case, the optics-relay OR comprises three simple lenses and the combiner is a concave reflecting surface. The optics-relay OR forms an image D′ of the image of the display D. This image D′ is collimated at infinity by the collimator C which reflects it back toward the eye Y of a user. This image may be superimposed or not onto the external scene. In the solutions according to the prior art, the mirror SA is a simple plane mirror allowing the optical beams to be folded back so as to optimize the volume and the ergonomy of the display system. In the system according to the invention, the mirror SA comprises an active surface. The operation of the system is as follows. At a given first time Ti such as shown in FIG. 4, the display device displays a region Zi of the object to be displayed, the law of deformation Li of the surface SA having been programmed so as to perfectly correct the geometric aberrations of the optical system for the region Zi. The user sees a perfectly sharp portion of image Z′i. At a given second time Tj, such as shown in FIG. 5, the display device displays a second region Zj of the object to be displayed, the law of deformation Lj of the surface SA having been programmed so as to perfectly correct the geometric aberrations of the optical system for this second region Zj. The user sees a perfectly sharp portion of image Zj. Thus, if the change of region is fast enough, the image seen region by region can be reconstituted in such a manner that the user sees a sharp image. The total display time for an image must be less than the duration of the retinal persistence.

The optical system according to the invention may be applied to a large number of optical applications, whenever the optical field is sufficiently large and the constraints of cost or of installation do not allow complex optical solutions to be adopted. It is just as applicable to systems designed to operate in the visible, ultraviolet or infrared spectrum.

1. A display system comprising a display device emitting an illuminated object and an optical system comprising at least a first optical element and a second adaptive optical element comprising at least one active component capable of modifying an optical wavefront received virtually instantaneously according to a predetermined law, said optical device being designed to produce an image of an illuminated object whose geometric and photometric characteristics are known, the image being at a finite distance or at infinity, the display device being composed of a plurality of adjacent regions, wherein to each region of the object there corresponds at least one predetermined law for modification of the active component in such a manner that the geometric aberrations of the region of the image given by the system and corresponding to said region of the object are minimized.

2. The display system as claimed in claim 1, wherein the active component is of the dioptric or catoptric type.

3. The display system as claimed in claim 1, wherein, if the illuminated object emits over a polychromatic spectrum, for a given region, there exist several predetermined laws for modification of said active component, each law corresponding to a range of predetermined wavelengths of the polychromatic spectrum of the illuminated object.

4. The display system as claimed in claim 1, wherein the adjacent regions composing the object are of different size, the size of each region being adapted to the amplitude and to the shape of the geometric aberrations to be corrected.

5. The display system as claimed in claim 1, wherein the adaptive optical element is disposed in the neighborhood of the pupil of the optical system.

6. A display system as claimed in claim 1, said system being arranged so as to produce an image at infinity of the illuminated object emitted by the display device, wherein the display device emits each illuminated object in a sequential manner, each region being emitted for a predetermined period of time, the predetermined law for modification of the active component corresponding to said region being applied to the active component for said predetermined period of time.

7. The display system as claimed in claim 6, wherein at least two regions emitted successively are adjacent.

8. The display system as claimed in claim 6, wherein said system is arranged so as to be carried by the head of a user.

9. A system for acquisition of images comprising at least one photoreceptor surface and an optical system comprising at least a first optical element and a second adaptive optical element comprising at least one active component capable of modifying an optical wavefront received virtually instantaneously according to a predetermined law, said system being arranged in such a manner that the image of the illuminated object is focused onto the photoreceptor surface, the photoreceptor surface being composed of a plurality of adjacent regions, wherein to each region of the photoreceptor surface there corresponds at least one predetermined law for modification of the active component in such a manner that the geometric aberrations of the region of the image given by the system are minimized and the photoreceptor surface acquires the image of the object in a sequential manner, each region being acquired for a predetermined period of time, the predetermined law of modification of the active component corresponding to said region being applied to the active component for said predetermined period of time.

10. The display system as claimed in claim 9, wherein at least two regions acquired successively are adjacent.
